(19) United States
(12) Patent Application Publication
(10) Pub. No.: US 2002/0196959 A1
(43) Pub. Date: Dec. 26, 2002

(54) Audio strap

(76) Inventor: Assaf Gurner, Newe Yaraq (IL)

Correspondence Address: SALTAMAR INNOVATIONS, 30 FERN LANE, SOUTH PORTLAND, ME, 04106, US

(21) Appl. No.: 09/886,905

(22) Filed: Jun. 21, 2001

(51) Int. Cl. H04R 5/02; H04R 1/02

(52) U.S. Cl. 381/333; 381/301

(57) ABSTRACT

An audio strap of speakers for playing audio information originating from an audio playback device is disclosed. The audio strap comprises a strap preferably made of material responsive to audio waves by way of resonating, and an array of speakers deployed on said strap. The array of speakers is divided into at least one of a plurality of separate groups of speakers, each group of speakers consisting of one or more speakers, the group separately electrically connected to a connector adapted to be plugged to an audio output socket of the audio playback device. Each group receives a separate electric signal from a separate channel of the audio playback device and produces an audio signal corresponding to the electric signal. When the speakers generate audio waves the strap resonates thus enhancing the sound of the speakers.

### FIELD OF THE INVENTION

The present invention relates to audio devices. More particularly it relates to an audio strap for the purpose of playing music or other audio playback material to prenatal babies or others.

### BACKGROUND OF THE INVENTION

Many child development experts believe that playing music to prenatal babies can enhance and improve their development and growth. All kinds and styles of music are believed to be suitable although most commonly it is accepted that classical music is most beneficial. This notion had brought about the introduction of audio devices aimed at playing music or other auditory material. Some example of such devices is given herein.

U.S. Pat. No. 4,830,007 (Stein), titled FETUS LEARNING SYSTEM, filed in 1987, disclosed a device for delivering recorded auditory information to a human fetus while in his mother's uterus. The device includes a playback device for translating recorded auditory information into corresponding electrical signals, a vibrating transducer for transducing said electrical signals into audible vibrations corresponding to said auditory information. The vibrating transducer is adapted to be positioned in substantially solid contact with the external surface of the abdominal area of the female carrying said fetus with substantially no free air space between the vibrating transducer and said external surface of said abdominal area so that vibrations of the vibrating transducer will vibrate the abdominal area of the female to cause auditory vibrations in the uterus of the female which can be heard by the fetus. A system of straps is provided to maintaining the vibrating transducers in substantially solid contact with the external surface of the abdomen of the female, which straps are adjustable to accommodate an increase in size of the abdominal area of the female, which occurs during gestation of the fetus.

In U.S. Pat. No. 4,934,998 (Thomas, Jr.), titled PRENATAL AUDIO APPARATUS, filed 1996, there was disclosed a prenatal audio apparatus includes a belt for fitting over a pregnant woman for directing audio sounds to the unborn baby. A belt has an inside surface, to fit against a pregnant woman's body, and an outside surface. Belt fasteners, such as hook and loop material, may adjustably attach the belt to the person. The belt can be made of a soft loop material fastenable for a hook material fastener portion. An audio signal source, such as a small portable tape recorder, is attachable to the belt. A pair of audio transducers are mounted in the belt in foam material with the output of the transducers facing the belt's inside surface, so that when attached to the patient, the sounds will be directed toward the unborn baby. The audio transducer is operatively connected to the audio signal source. The audio signal source may also be connected to earphones worn by the woman carrying the baby.

U.S. Pat. No. 5,491,756 (Francais), titled SYSTEM FOR DELIVERING SOUND AND MONITORING EFFECTS ON FETUS, filed 1993, disclosed a system for generating and delivering sound to a fetus through the mother's abdomen and which also allows monitoring of the effects of sound on the fetal child. The system comprises a belt adapted to be worn about the abdomen area of the mother and includes speakers located in the region of the fetal child for imparting sound through the abdomen wall to the fetal child. The speakers are connected to a sound generator, such as a tape recorder or the like. A stethoscope sensor is mounted in and carried by the belt and is also located in juxtaposition to the abdomen in proximity to the fetal child in order to determine the effects of the sounds on the fetal child. The stethoscope sensor is attachably connected to a stethoscope adapted to be worn by the mother or other user.

In U.S. Pat. No. 5,873,736 (Harrison), titled PRENATAL MUSIC BELT, filed in 1997, there was disclosed a prenatal music belt for sharing the soothing effects of music and the like with an unborn child. The device includes an elongated, elastic belt with a buckle at one end of the belt for readily permitting adjustments to the size of the belt. A pair of pockets are attached by loops to the belt so that the position of the pockets can be adjusted to any position along the belt. The pockets are sized and shaped for retaining earphones from a sound playback device therein, with the earphone being directed towards the mother's abdomen so that sound from the earphones is directed towards the fetus. The sound playback device is attached by a clip to the belt at any position therealong which is comfortable to the wearer. The pockets are closed by VELCRO/hook and loop type fasteners in order retain the earphones therein.

It is noted that the embodiments presented in the above referenced patents usually employ two speakers, and two only.

It is an object of the present invention to provide an audio strap made of a plurality of speakers—vibrating transducers—arranged in a predetermined arrangement on a strap that is adapted to be worn by a pregnant woman, so as to allow playing of music or other audio information to the woman's prenatal baby.

Another object of the present invention is to provide such an audio strap that is suitable for attachment (or placement closely) inside a baby's pram about the baby's head.

Yet another object of the present invention is to provide such an audio strap that is adapted to be attached to a seat's headrest, so as to allow the head of a person sitting on the seat to be surrounded by music.

Still another object of the present invention is to provide such an audio strap that is adapted to be attached over a garment's collar, preferably with the collar is in an upright position, so as to allow the wearer's head to be surrounded by the music played.

More objects and advantages of the present invention will become apparent from the following detailed descriptions when read in conjunction with the accompanying drawings.

### BRIEF DESCRIPTION OF THE INVENTION

A main concept of the present invention is to use a plurality of speakers to provide a short range qualitative music playing system that does not interfere with the environment such as a normal amplified two speakers system would, still provide a rich broad sound created by filling the space close the user's ears.

Qualitative music playback in general has to do with the distance between the speakers and the user's ears. Headphones require close coupling of the speakers to the ears.

The present invention suggests using a plurality of speakers to provide freedom to the listener's head yet ensuring that when his head spins he will always be close enough to at least one pair of speakers.

Another effect achieved from the plurality of speakers is attributed to the fact that the sound produced by each speaker is always slightly different from the other speakers (tolerances in production and the different positioning in space). This results in harmonies created by the different overtones produced by each speaker that create a similar effect to that created by powerful expensive speakers (in the vicinity of the speakers).

It is not trivial to provide a system with more than two speakers since such a system will need an external amplifier (most playback devices have two sound outputs, one is a “line” that sends a low power signal and must use an amplifier, the other one is “phones” that can activate two low power speakers designated to couple to the ears. Obviously when attaching more speakers to that output the power of the output is distributed between the speakers and results in a total that is equal to the power that would be distributed between the two speakers of known portable sound systems. Since it is not desired to use an amplifier that will consume power and make the system less portable requiring batteries that make the system limited at playback time, inflict expenses and imparts more hassle to the user. By coupling the plurality of speakers configuration to a belt made of materials with resonantic qualities (they do not absorb most of the sound but rather reflect) and by so doing the sound is amplified by mechanical means thus exploiting the speakers' vibrations more efficiently.

It is therefore thus provided, in accordance with a preferred embodiment of the present invention, an audio strap of speakers for playing audio information originating from an audio playback device, the audio strap comprising:

a strap; and

an array of speakers deployed on said strap, the array of speakers divided into at least one of a plurality of separate groups of speakers, each group of speakers consisting of one or more speakers, the group separately electrically connected to a connector adapted to be plugged to an audio output socket of the audio playback device, receive separate electric signal from a separate channel of the audio playback device and produce an audio signal corresponding to the electric signal.

Furthermore, in accordance with another preferred embodiment of the present invention, said strap is made of material responsive to audio waves by way of resonating.

Furthermore, in accordance with another preferred embodiment of the present invention, said strap is made from a foamed polymer.

Furthermore, in accordance with another preferred embodiment of the present invention, the foamed polymer consists of foamed polyethylene.

Furthermore, in accordance with another preferred embodiment of the present invention, said strap is coated with fabric or other coating material, so as to present a smooth surface texture.

Furthermore, in accordance with another preferred embodiment of the present invention, the strap is provided with fastening means for fastening it when mounted about an object.

Furthermore, in accordance with another preferred embodiment of the present invention, said fastening means comprise Velcro fastening patches that allow adjustment of the strap in various sizes about the abdomen of a pregnant woman.

Furthermore, in accordance with another preferred embodiment of the present invention, said fastening means comprise fastening straps provided with snap fasteners for engagement.

Furthermore, in accordance with another preferred embodiment of the present invention, said fastening straps are flexible so as to be extended and flex back thus conveniently allow mounting the audio strap in position over the object.

Furthermore, in accordance with another preferred embodiment of the present invention, the strap is provided with bores distributed along the strap and wherein each speaker of the array of speakers is disposed in one of the bores.

Furthermore, in accordance with another preferred embodiment of the present invention, the diameter of each bore is large enough so that the speaker squeezingly fits inside.

Furthermore, in accordance with another preferred embodiment of the present invention, the speakers are adhered to the strap.

Furthermore, in accordance with another preferred embodiment of the present invention, the speakers are mounted by pressure onto the strap.

Furthermore, in accordance with another preferred embodiment of the present invention, said speakers are all directed with their membranes facing in one direction.

Furthermore, in accordance with another preferred embodiment of the present invention, the array of speakers consists of four or more speakers.

Furthermore, in accordance with another preferred embodiment of the present invention, the speakers are electrically connected to the plug by electrical wiring or using a printed circuit concealed within the strap.

Furthermore, in accordance with another preferred embodiment of the present invention, said array of speakers is divided into two separate groups of speakers so as to allow the generation of stereo sound.

Furthermore, in accordance with another preferred embodiment of the present invention, said array of speakers is divided into three, five or six separate groups of speakers so as to allow the generation of surround sound.

Furthermore, in accordance with another preferred embodiment of the present invention, the speakers are each about 1.5 inch in diameter, about 8 ohms impedance, and 0-3 watts RMS.

Furthermore, in accordance with another preferred embodiment of the present invention, said array of speakers comprises a single row of speakers.

Furthermore, in accordance with another preferred embodiment of the present invention, said array of speakers comprises a plurality of rows of speakers.

Furthermore, in accordance with another preferred embodiment of the present invention, said plurality of rows of speakers comprises three rows of speakers.

Furthermore, in accordance with another preferred embodiment of the present invention, the strap is provided with attaching means for attaching the strap onto a collar of a garment.

Furthermore, in accordance with another preferred embodiment of the present invention, said attaching means comprise Velcro patches.

Furthermore, in accordance with another preferred embodiment of the present invention, the strap is made of a flexible material.

Furthermore, in accordance with another preferred embodiment of the present invention, the strap is further provided with a leg so as to support it in an upright position.

Finally, in accordance with another preferred embodiment of the present invention, there is provided an audio strap of speakers for playing audio information originating from an audio playback device, the audio strap comprising:

a strap made of material responsive to audio waves by way of resonating; and

an array of speakers deployed on said strap, the array of speakers divided into at least one of a plurality of separate groups of speakers, each group of speakers consisting of one or more speakers, the group separately electrically connected to a connector adapted to be plugged to an audio output socket of the audio playback device, receive separate electric signal from a separate channel of the audio playback device and produce an audio signal corresponding to the electric signal,

whereby when the speakers generate audio waves the strap resonates thus enhancing the sound of the speakers.

### BRIEF DESCRIPTION OF THE FIGURES

In order to better understand the present invention, and appreciate its practical applications, the following Figures are provided and referenced hereinafter. It should be noted that the Figures are given as examples only and in no way limit the scope of the invention as defined in the appending Claims. Like components are denoted by like reference numerals.

FIG. 1 illustrates an audio strap in accordance with a preferred embodiment of the present invention, worn by a pregnant woman about her abdomen.

FIG. 2 illustrates an audio strap attached to a baby's swing.

FIG. 3 illustrates an audio strap in accordance with another preferred embodiment of the present invention, with a single row of speakers.

FIG. 4 illustrates an audio strap in accordance with another preferred embodiment of the present invention, with a plurality of rows of speakers.

FIG. 5 depicts an audio strap attached to a baby's pram back support over the baby's head.

FIG. 6 illustrates an audio strap attached to a jacket's collar about the wearer's head.

FIG. 7 illustrates a pair of audio straps used as loudspeaker assembly for portable stereo audio playback devices

### DETAILED DESCRIPTION OF THE INVENTION AND FIGURES

An aspect of the present invention is the provision of an audio strap comprising a flexible strap in which a plurality of speakers are arranged so as to provide wide auditory front (such as a stereo sound, surround sound etc.).

Another aspect of the present invention is the provision of an audio strap that may be strapped on about a pregnant woman's waist over her abdomen. In a preferred embodiment the strap has adjustable length so as to allow its wearing by women at different pregnancy stages.

Another aspect of the present invention is the provision of a multi-purpose audio strap that may be attached in a position near the user's head, such as on a baby's pram inside wall near the baby's head, on a seat's headrest, on a collar of a garment etc.

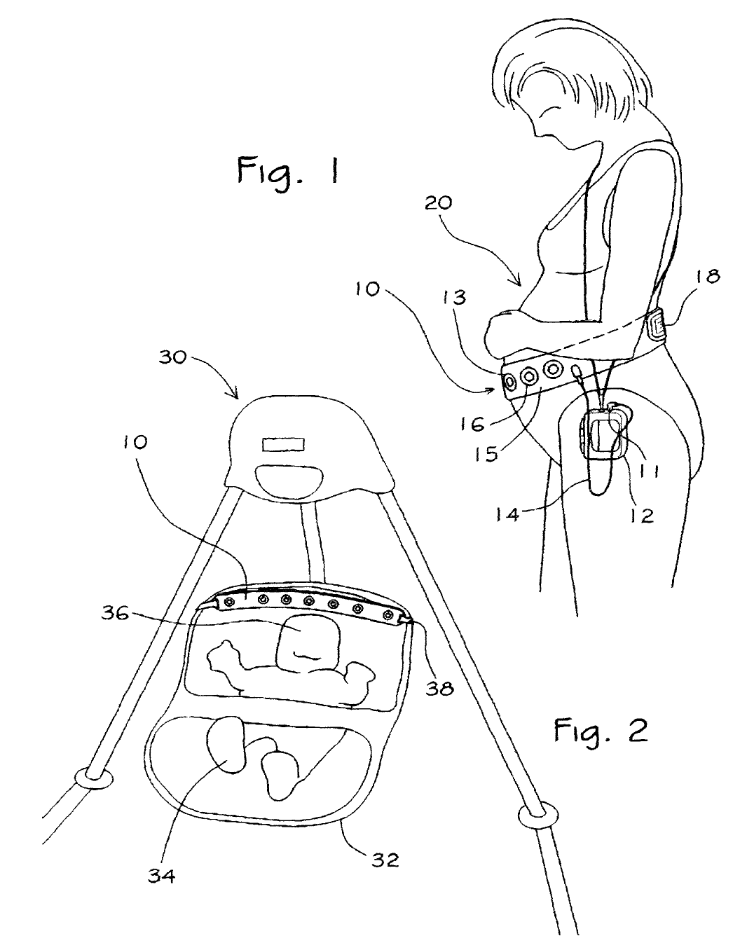

Reference is now made to FIG. 1, illustrating an audio strap in accordance with a preferred embodiment of the present invention, worn by a pregnant woman about her abdomen.

The audio strap 10 generally comprises a flexible strap 15 that is adapted to be worn by a pregnant woman 20 about her abdomen. The strap in FIG. 1 is provided with Velcro fastening patches 18 that allow adjustment of the strap in various sizes about the abdomen. The audio strap may be made from a flexible yet strong material (strong enough to withstand reasonable tearing forces). An array of speakers, comprising a plurality of speakers 16, is inserted in matching bores 13 that are arranged in a predetermined configuration along the strap 15. The speakers are preferably all directed with their membrane facing in one direction, but may also be arranged to be directed in opposing directions too (the sound quality and power at either sides of many flat speakers is substantially the same). The arrangement of the speakers is aimed at distribution of the sound generated by these speakers in a confined space when the strap is arranged in a convergent manner and it is recommended that the speakers'arrangement occupies a substantial portion of the strap so that sound is generated form large portions of the strap. This can be accomplished by providing a relatively large number of speakers, such as 4, 5, or more (up to a dozen speakers seem like a very good choice). The strap shown in FIG. 1 hosts eleven speakers. This distribution of speakers renders the audio strap a unique acoustic quality: it takes relatively low power to produce good acoustic sound in the near vicinity of the speaker array, whereas further away from the audio strap this sound is hardly noticeable. This is an important advantage since it offers the user private usage without disturbing others in the surroundings. A pregnant woman may wear the audio strap while at work without disturbing her fellow workers, jog or walk with her actively playing audio strap and perform all day-to-day tasks and actions without being noticed or pose any inconveniences on her surroundings.

In a preferred embodiment of the present invention the diameter of each bore is large enough so that the speaker squeezingly fits inside. In other words, the material of the strap tightly holds the speaker in position. This arrangement provides for an important advantage of the audio strap of the present invention: when the speakers generate sound it also vibrates through the strap material and resonates within. The resonance effect of the strap material improves the sound in the vicinity of the strap, thus allowing low power input and at the same time very good sound quality near the audio strap without substantial auditory nuisance to the surroundings. This can also be achieved by other ways of coupling such as adhering the speakers to the belt, mounting by pressure etc., For best sound performance, the belt has to be made of a material with qualities that allow it to resonate.

It is noted, though, that the present invention is not limited to speaker arrangement hosted within bores in the strap only. This means that an amplifier is not a required component of the audio strap, thus eliminating the need for a power source such as battery. However, incorporating an amplifier in the audio strap is indeed a possibility, and as such also covered by the scope of the present invention.

The speaker array is electrically connected via electric wiring or other conducting means (such as printed circuit imprinted in the strap) through an external connecting wire 14 to a plug 11 (such as a 3.5 mm standard stereo plug) adapted to be plugged to an audio output signal socket of an audio playback device 12, such as a CD (compact disc) player, FM/AM radio or the like. In a preferred embodiment of the present invention the electrical wiring of the speakers is concealed within the strap. This can be accomplished in various ways, for example by manufacturing the strap from two thinner straps that are joined together overlapped by adhering them and leaving the wiring hidden between the joined straps, or by incorporating the wiring or electrical conducting means in other way within the strap.

In order to obtain stereo sound the speaker array may be divided into two groups of speakers each group (consisting of one or more speaker) substantially separated in space in order to separate the sound generated from that group from the sound of the other group of speakers, each group receiving separate signal from a separate channel of the audio playback device. Other sound arrangements are possible too. For example, 3 separate groups of speakers for 3 separate channels (Dolby surround), or 5 or 6 separate group of speakers for 5 or 6 channel signal (Dolby digital or DTS sound systems), etc.

The speakers are preferably relatively flat speakers, for example the speakers manufactured and distributed by VECO (Taiwan), each speaker 1.5 inch in diameter, 8 ohms impedance, 0-3 watts RMS. Being flat makes the speakers merge with the strap and not bulge beyond the strap surface. This means that the strap width should be such that it substantially retains the width of the speakers between its two opposite outer surfaces. For the VECO speakers mentioned hereinabove the strap width should preferably be about 5 mm. As most audio playback devices require 8 ohms impedance for the speakers to optimally perform, it is suggested to connect the speaker array in a configuration that presents an overall impedance of 8 ohms. This is possible, for example by connecting in series pairs of 8 ohms speakers, connected in parallel, thus retaining impedance of 8 ohms or by using resistors.

The strap itself may be made from a foamed polymer, such as foamed polyethylene or other similar material. It is recommended to coat the foamed polymer with fabric 23 or other coating so as to render the audio strap smooth surface texture and thus making it convenient for wearing (even on bare skin).

FIG. 2 illustrates an audio strap with 7 speakers attached to a baby's swing 30 on which seat 32 a baby 34 is seated. At the back support of the seat 32 of baby's swing 30, an audio strap 10 is attached in the vicinity of the baby's head 36, the strap provided with fastening straps 38. Straps 38 may optionally be flexible straps that may be extended and flex back so as to conveniently set the audio strap in position over a seat's back support. This allows the baby to experience surround sound generated from the audio strap (this is so even if the music source is mono).

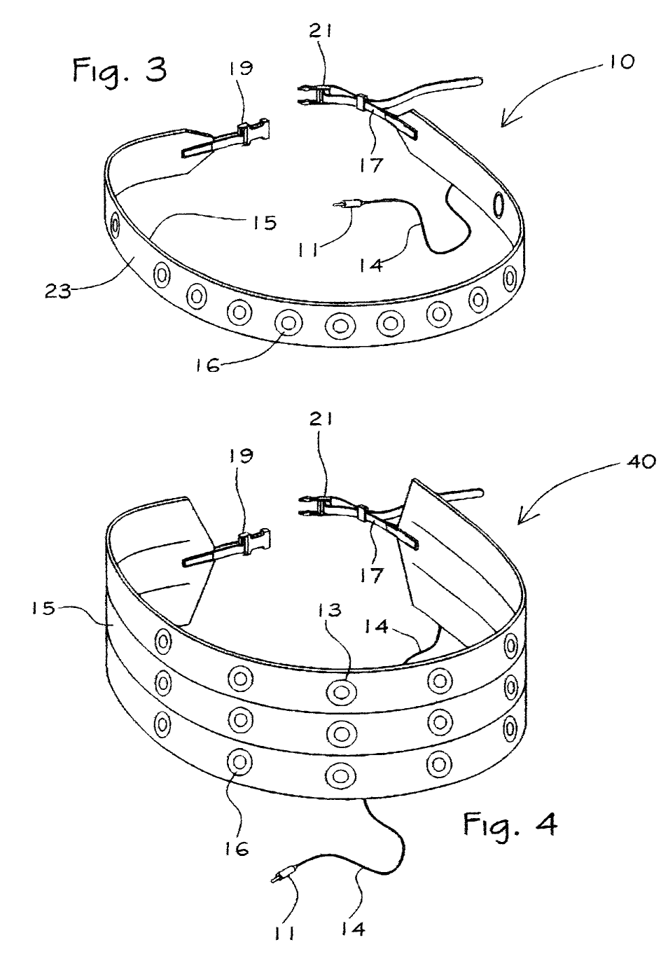

FIG. 3 illustrates an audio strap in accordance with another preferred embodiment of the present invention, with a single row of speakers 16. The strap is provided with fastening straps 17 of adjustable length and matching snap fasteners 19, 21 for engagement.

FIG. 4 illustrates an audio strap in accordance with another preferred embodiment of the present invention, with a plurality of rows of speakers. In this embodiment the audio strap 40 comprises a strap 15, wider than the strap shown in FIG. 1, provided with a two dimensional array of speakers 16 consisting of three rows of speakers, altogether hosting 15 speakers. This embodiment is preferable when it is desired to have a laterally wide auditory wave front. This is suitable for many purposes such as deploying the strap on a wall in the vicinity of the listener—a baby or a grown up alike, or for any other purpose. The strap is provided with fastening straps 17 of adjustable length and matching snap fasteners 19, 21 for engagement.

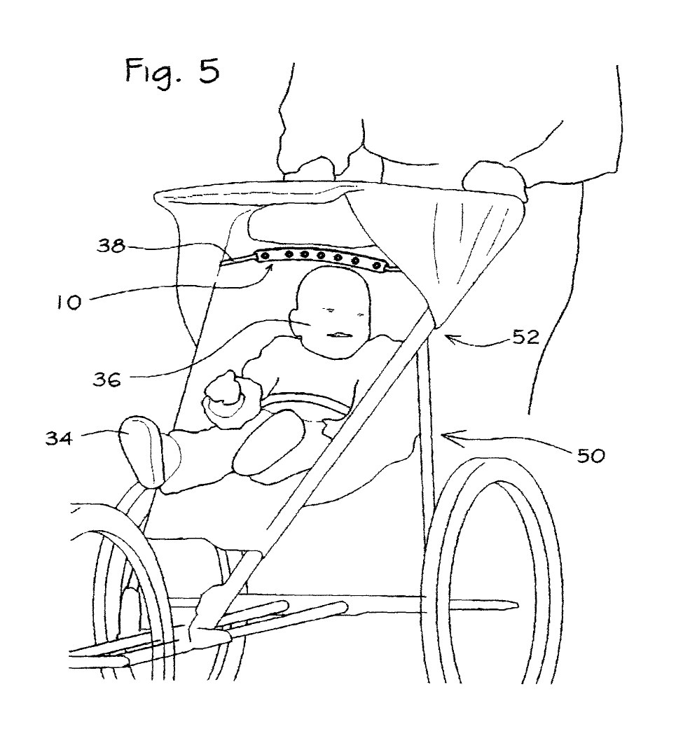

FIG. 5 depicts an audio strap attached to a baby's pram back support over the baby's head. The audio strap is mounted over the pram's back support 52 over the baby's head 36.

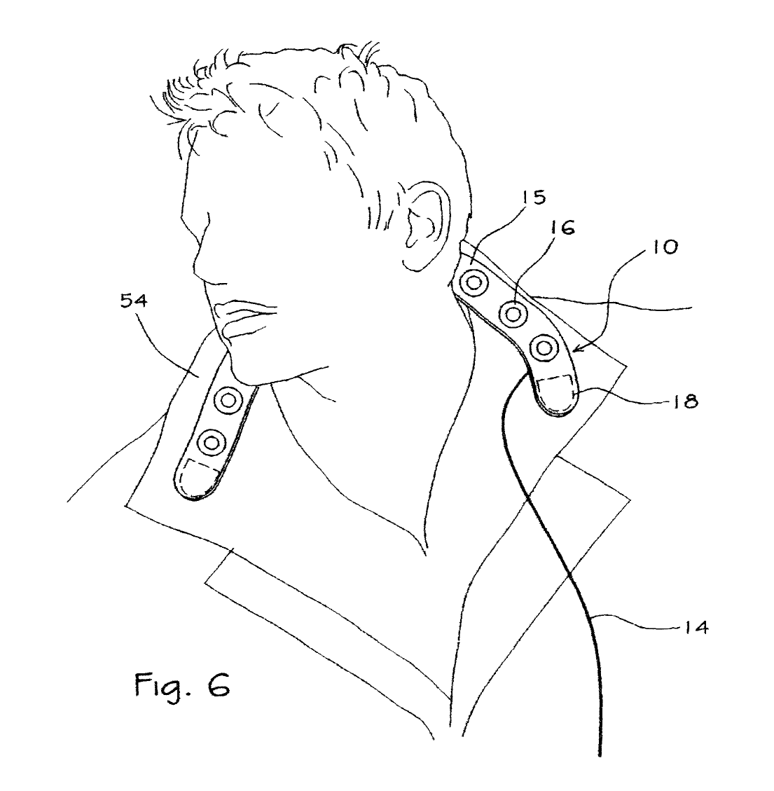

FIG. 6 illustrates an audio strap 10 attached to a jacket's collar 54 about the wearer's head. This is a chic application of the audio strap that is believed to become very popular, especially among the youth. In this embodiment the strap is provided with Velcro patches 18 so that it may be attached on a collar of a garment—here a jacket. A person may wear the audio strap over his jacket's collar, and listen to music or other audio information played from the audio strap. It is recommended to use the audio strap with the collar in an upright position so that it practically surrounds the listener's head.

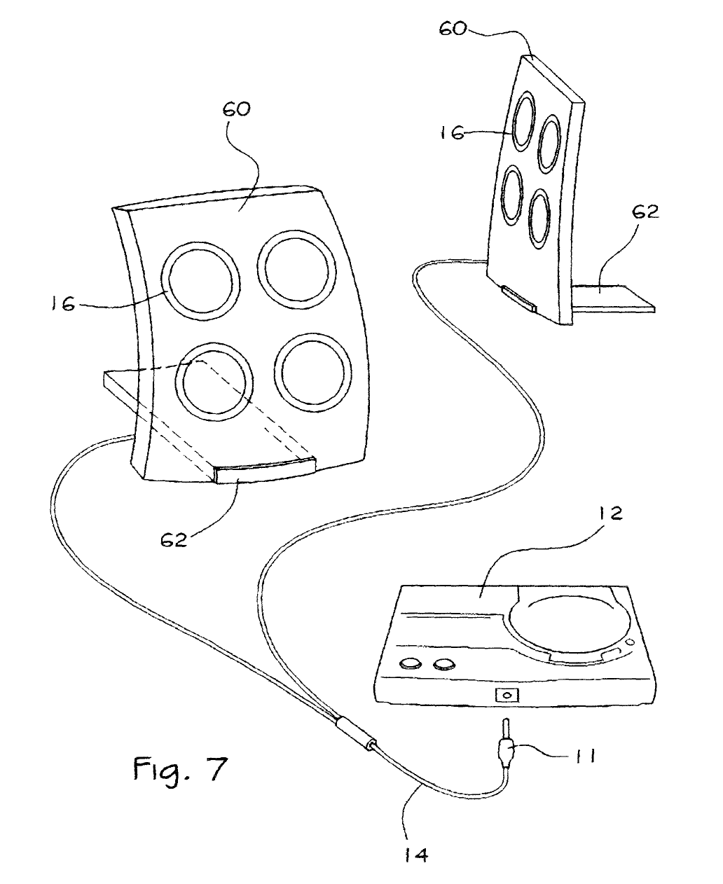

FIG. 7 illustrates another preferred embodiment of the present invention—a pair of loudspeaker assembly for portable stereo audio playback devices. Each loudspeaker assembly 60 comprises a strap made of resonating material, such as foamed polymer, and includes a plurality of speakers 16. Each strap is provided with a leg 62, so as to support it in an upright position. The leg may be made of any solid material such as wood, plastic, metal etc. The speaker assemblies are each connected to the headphones socket of the audio device 12 by wiring 14.

Obviously the sizes and measures indicated hereinabove are only given as an example and in no way limit the scope of the present invention as defined in the appending Claims.

It should be clear that the description of the embodiments and attached Figures set forth in this specification serves only for a better understanding of the invention, without limiting its scope as covered by the following Claims.

It should also be clear that a person skilled in the art, after reading the present specification could make adjustments or amendments to the attached Figures and above described embodiments that would still be covered by the following Claims.

1. An audio strap of speakers for playing audio information originating from an audio playback device, the audio strap comprising:
a strap; and
an array of speakers deployed on said strap, the array of speakers divided into at least one of a plurality of separate groups of speakers, each group of speakers consisting of one or more speakers, the group separately electrically connected to a connector adapted to be plugged to an audio output socket of the audio playback device, receive separate electric signal from a separate channel of the audio playback device and produce an audio signal corresponding to the electric signal.

2. The audio strap of claim 1, wherein the strap is made of material responsive to audio waves by way of resonating.

3. The audio strap of claim 1, wherein said strap is made from a foamed polymer.

4. The audio strap of claim 3, wherein the foamed polymer consists of foamed polyethylene.

5. The audio strap of claim 1, wherein said strap is coated with fabric or other coating material, so as to present a smooth surface texture.

6. The audio strap of claim 1, wherein the strap is provided with fastening means for fastening it when mounted about an object.

7. The audio strap of claim 6, wherein said fastening means comprise Velcro fastening patches that allow adjustment of the strap in various sizes about the abdomen of a pregnant woman.

8. The audio strap of claim 1, wherein said fastening means comprise fastening straps provided with snap fasteners for engagement.

9. The audio strap of claim 8, wherein said fastening straps are flexible so as to be extended and flex back thus conveniently allow mounting the audio strap in position over the object.

10. The audio strap of claim 1, wherein the strap is provided with bores distributed along the strap and wherein each speaker of the array of speakers is disposed in one of the bores.

11. The audio strap of claim 10, wherein the diameter of at least one bore is sufficiently dimensioned to squeezingly fit a speaker therein

12. The audio strap of claim 10, wherein the speakers are adhered to the strap.

13. The audio strap of claim 10, wherein the speakers are mounted by pressure onto the strap.

14. The audio strap of claim 1, wherein said speakers are all directed with their membranes facing in one direction.

15. The audio strap of claim 1, wherein the array of speakers consists of four or more speakers.

16. The audio strap of claim 1, wherein the speakers are electrically connected to the connector by electrical wiring or by a printed circuit concealed within the strap.

17. The audio strap of claim 1, wherein said array of speakers is divided into two separate groups of speakers so as to allow the generation of stereo sound.

18. The audio strap of claim 1, wherein said array of speakers is divided into three, five or six separate groups of speakers so as to allow the generation of surround sound.

19. The audio strap of claim 1, wherein the speakers are each about 1.5 inch in diameter, about 8 ohms impedance, and 0-3 watts RMS.

20. The audio strap of claim 1, wherein said array of speakers comprises a single row of speakers.

21. The audio strap of claim 1, wherein said array of speakers comprises a plurality of rows of speakers.

22. The audio strap of claim 21, wherein said plurality of rows of speakers comprises three rows of speakers.

23. The audio strap of claim 1, wherein it is provided with attaching means for attaching the strap onto a collar of a garment.

24. The audio strap of claim 23, wherein said attaching means comprise Velcro patches.

25. The audio strap of claim 1, wherein the strap is made of a flexible material

26. The audio strap of claim 1, wherein it is further provided with a leg so as to support said strap in an upright position.

27. An audio strap of speakers for playing audio information originating from an audio playback device, the audio strap comprising:
a strap made of material responsive to audio waves by way of resonating; and
an array of speakers deployed on said strap, the array of speakers divided into at least one of a plurality of separate groups of speakers, each group of speakers consisting of one or more speakers, the group separately electrically connected to a connector adapted to be plugged to an audio output socket of the audio playback device, receive separate electric signal from a separate channel of the audio playback device and produce an audio signal corresponding to the electric signal,
whereby when the speakers generate audio waves the strap resonates thus enhancing the sound of the speakers.
